(19) United States
(12) Patent Application Publication
(10) Pub. No.: US 2004/0181819 A1
(43) Pub. Date: Sep. 16, 2004

(54) System and method for scheduling in-theatre advertising

(76) Inventors: Christopher H. Theiste, Plymouth, MN (US); Joseph Agee, Richfield, MN (US); Thomas J. Schmidt, Highlands Ranch, CO (US)

Correspondence Address: Stuart T. Langley, Esq., Hogan & Hartson, LLP, Suite 1500, 1200 17th Street, Denver, CO, 80202, US

(21) Appl. No.: 10/386,366

(22) Filed: Mar. 11, 2003

(51) Int. Cl. H04N 7/16; H04N 7/18

(52) U.S. Cl. 725/146; 725/135; 725/136; 725/28; 725/82

(57) ABSTRACT

A method of scheduling pre-show feature presentations in a theatre by providing content items in a theatre server. A plurality of advertising contract records are stored at the theater server, where each advertising contract record identifies at least one content item. The advertising contract records include scheduling data associated with that particular content item, wherein the scheduling data includes at least one item of information that correlates to a particular presentation criterion that must be satisfied when the content is presented. Theatre schedule information indicates particular feature presentations that will be presented in particular auditoriums and includes the scheduling information including at least one attribute of the feature presentation. A pre-show play list is built for a particular auditorium by selecting contract records that will have their presentation criteria satisfied by the at least one attribute specified in the theatre schedule information arranging content items associated with each of the selected contract records to form the pre-show play list.

### BACKGROUND OF THE INVENTION

1. Field of the Invention.

The present invention relates, in general, to systems and methods for displaying movies, advertising, and alternative content, and, more particularly, to software, systems and methods for scheduling pre-show presentations in conjunction with a feature presentation.

2. Relevant Background.

In-theatre advertising refers to advertising that is delivered in conjunction with a film being shown at a theatre. Typically these advertisements are displayed using some or all of the theatre projection equipment, audio equipment and screens. Advertisements are presented during the times between feature presentations while audiences are being seated and waiting for a feature to begin.

In-theatre advertising has many advantages over traditional media. One of the biggest advantages is that the theatre environment is a unique setting where patrons are predisposed to attentively receive multimedia presentations. Unlike television, billboards and newspapers, a movie theatre is an environment where the audience intends to listen, watch, and be receptive to what is presented. Each theatre holds a relatively small audience, but this offers opportunities to more specifically target advertising to the needs of that audience. While movies appeal to a variety of demographics, the theatre audience at any particular showing has certain inherent characteristics in common. These common characteristics are what brought the people together in the theatre such as interest in a particular movie, genre, or rating. Also, the audience at any given showing have some geographic similarity, and often similar work and free time schedules.

To date, one of the biggest advantages of in-theatre advertising has been its low cost as compared to television, radio, billboards and newspapers. Part of the reason for this is that existing in-theatre advertising fails to capitalize on the unique ability to target advertisements to a particular audience that has gathered to view a particular feature at a particular time and place. As a result, in-theatre advertising does not attract high-quality national advertisers and instead serves local markets that are proximate to the theatre facility.

Examples of in-theatre advertising include a pre-feature slide show that displays a repeating loop of advertising slides, often interspersed with entertainment slides. The loop is started at some arbitrary time between shows and repeats until the upcoming feature begins. The loop repeats while the audience is seated such that an ad may appear several times before the feature presentation begins. Optionally, the feature presentation is preceded by trailers advertising other films. Hence, an advertiser that uses the pre-show slide program cannot predict, nor can the theatre owner guarantee, how many times a particular advertisement will be viewed nor when the advertisement will be viewed with respect to the beginning of the feature presentation. It is known that certain times in the pre-show are more valuable than other times from an audience size and attention standpoint. For example, the moments immediately preceding a feature are more valuable than times that are twenty to thirty minutes before the feature. Because current in-theatre advertising systems cannot place an advertisement with precision, the theatre owner is unable to tailor the presentation to particular advertiser needs and desires. As a result, the theatre owner cannot vary the cost of the advertisement to account for the actual value of the specific times at which an advertisement will be presented. Specifically, it would be desirable to be able to schedule pre-show features with such precision that a theatre owner can charge a premium for premium times, and offer discounts for less than premium times.

More recently, “rolling stock” advertisements have become available in which a short animated feature, film, or other moving-picture feature is presented. Usually, the rolling stock is physically spliced to the beginning of a 35 mm feature film. As a result, there is no flexibility to alter when the rolling stock appears relative to the film, the rolling stock advertisement cannot be repeated during the pre-show as can slides, and the rolling stock will only appear immediately before the feature presentation. Although rolling stock advertisement has significantly more impact to certain demographics than slides, these constraints limit the applicability, effectiveness and variety of advertisers that can make use of rolling stock advertisement. A need exists for systems and methods that enable a pre-show presentation that has an impact comparable to rolling stock with the flexibility of slide programs, while offering a level of control and scheduling that is not currently available.

It would also be desirable if in-theatre advertising could be scheduled to more specifically target various audience characteristics. Because current techniques rely almost exclusively on the theatre location, advertisements are primarily location-based. Typically, local plumbing and heating contractors, restaurants, and businesses are primary advertisers of current in-theatre advertising. While in-theatre advertising is effective for these advertisers, it fails to leverage the other common characteristics that are shared by the audience. For example, in many theatres the same pre-show will be displayed for movies rated for a general audience (i.e., G-rating) as will be shown for movies rated for an adult audience (i.e., R-rating). Not only does this system fail to capture the value of being able to target the audience, but is also makes it difficult for some advertisers to even participate. An advertisement for a new sports car may be ineffective in an audience of juveniles as would an advertisement for a children's game presented before a feature directed at a teen-age audience. Accordingly, it would be desirable to schedule pre-show features in a way that targeted specific audience characteristics.

The ambiance of a theatre is what continues to draw audiences even though many other venues for watching movies exist. The ambience created by lighting, sound, seating, picture quality, and other factors contribute to a unique entertainment environment. The audience itself plays an important role in the ambience as the individuals who attend a given presentation affect each other. The controlled theatre environment is designed to put the audience in a receptive frame of mind and keep them in that frame of mind. However, current in-theatre advertising fails to take full advantage of this environment because such things as lights dimming, background audio, and the like are not synchronized with the pre-show features. Further, advertisers cannot control where the advertisement will be presented relative to other advertisements. In essence, although the theatre environment is designed to present a carefully controlled production, current practices make little use of this capability in the pre-show features.

One difficulty in marketing space during pre-show features has been an inability to schedule individual features, such as advertisements, in a way that ensured the feature would be presented at a desired time and place to an audience with desired characteristics. A theatre operator needs significant flexibility to schedule particular films in particular auditoriums. This schedule often changes daily if not throughout the day to meet varying audience demands. In contrast, the pre-show advertising space is usually sold weeks or months in advance. Hence, at the time the advertisement is sold the theatre operator does not have visibility into what films will be shown in which auditoriums nor any other indicia of the audience characteristics that describe who will view a particular advertisement. Essentially, the theatre operator had one item of pre-show inventory that it could sell to particular advertisers. A need exists for a pre-show feature scheduling system and method that creates varied types of inventory of pre-show advertising space that can be marketed to advertisers well in advance of the actual presentation.

In view of the above, there is an acute need for a new in-theatre advertising scheduling and distribution system that will overcome the above shortcomings of current in-theatre advertising practices.

### SUMMARY OF THE INVENTION

Briefly stated, the present invention involves a method of scheduling pre-show feature presentations in a theatre by providing content items in a theatre server. A plurality of advertising contract records are stored at the theatre server, where each advertising contract record identifies at least one content item. The advertising contract records include scheduling data associated with that particular content item, wherein the scheduling data includes at least one item of information that correlates to a particular presentation criteria that must be satisfied when the content is presented. Theatre schedule information indicates particular feature presentations that will be presented in particular auditoriums and includes the scheduling information including at least one attribute of the feature presentation. A pre-show play list is built for a particular auditorium by selecting contract records that will have their presentation criteria satisfied by the at least one attribute specified in the theatre schedule information arranging content items associated with each of the selected contract records to form the pre-show play list.

In another respect, the present invention involves a movie theatre having a plurality of auditoriums and presentation mechanisms within each auditorium operable to present visual and/or audio features to an audience. A central point of sale mechanism is provided for scheduling a particular feature presentation that will appear in a particular auditorium. Alternatively, a management tool separate from or instead of the point of sale mechanisms may be provided where integration with a point of sale system is not available or practical. This embodiment of the invention includes a system for presenting a plurality of pre-shows before feature presentations, where each pre-show is specified for a particular auditorium and each pre-show comprises a sequence of media files. In a specific instance, the system for presenting includes a pre-show play list data structure for each pre-show, the play list data structure defining the sequence of media files that make up the pre-show, media player components coupled to the presentation mechanisms and operable to play the sequence of media files defined by the pre-show play list, update services executing in the system for presenting and operable to detect changes that impact any one of the pre-show play lists, and a play list generator operable to create a replacement pre-show data structure in response to identifying a pre-show play list that is impacted by a change.

### BRIEF DESCRIPTION OF THE DRAWING

FIG. 1 shows a networked theatre environment in which the present invention is implemented;

FIG. 2 shows an exemplary theatre implemented in accordance with the present invention in functional block-diagram form;

FIG. 3 illustrates in functional block-diagram form auditorium components of a theatre system in accordance with the present invention;

FIG. 4 shows an exemplary theatre server components in accordance with the present invention in functional block-diagram form;

FIG. 5 shows data center components in accordance with the present invention;

FIG. 6 illustrates an exemplary scheduling architecture in accordance with a particular implementation of the present invention;

FIG. 7 shows an exemplary scheduling record in accordance with the present invention;

FIG. 8 illustrates an exemplary theatre schedule database in accordance with the present invention;

FIG. 9 shows an exemplary scheduling grid data structure used in a particular embodiment of the present invention; and

FIG. 10 shows an exemplary “queue table” data structure used in a particular embodiment of the present invention.

### DETAILED DESCRIPTION OF THE PREFERRED EMBODIMENTS

The present invention is illustrated and described in terms of a distributed theatre environment such as might be implemented by a national chain of theatres or an organization of cooperating independent theatre owners. However, the present invention is readily scaled to provide both international and local services, and may be implemented in a single venue. It should be understood that while the exemplary implementations involve pre-show features, the present invention is broadly applicable to scheduling features at any time before, during, and after a main feature. Moreover, while the examples are primarily provided in-theatre environments, it is contemplated that other entertainment venues and types may benefit from the present invention.

It is contemplated that the present invention will find applicability in many events that consist of or comprise the presentation of digital media or multimedia content. An “event” is construed broadly to mean live performances, live broadcasts or transmissions, as well as performances and transmissions of pre-recorded events. An event may take a single moment in time, or span a period of time. An event may itself comprise a continuous or discontinuous sequence of events. For example, live, broadcast, and multicast events such as concerts, sporting events, plays, speeches and the like may beneficially employ features of the present invention. Further, the present invention may be used to include pre-recorded features before, during, or after a primary feature presentation.

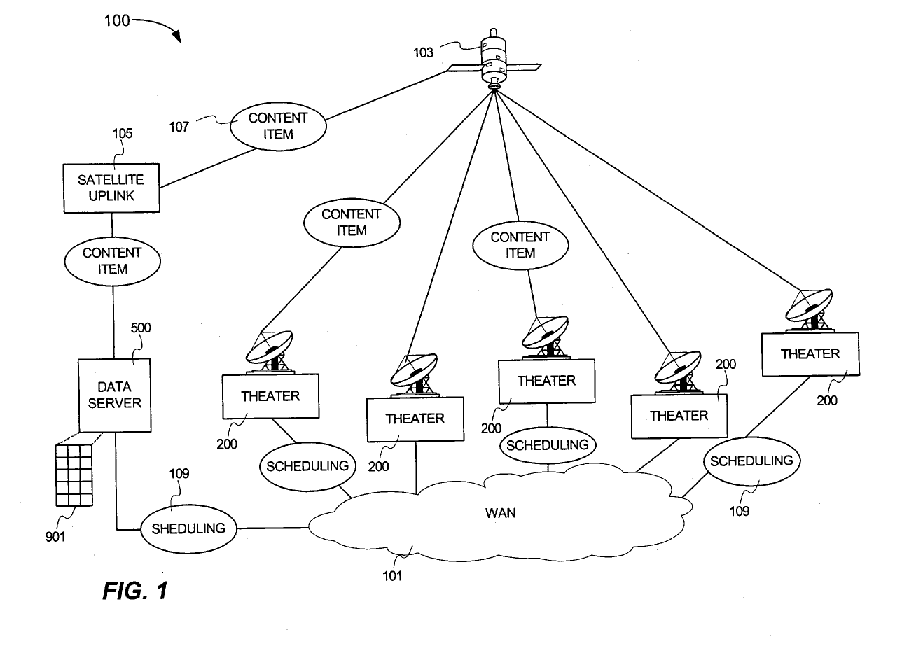

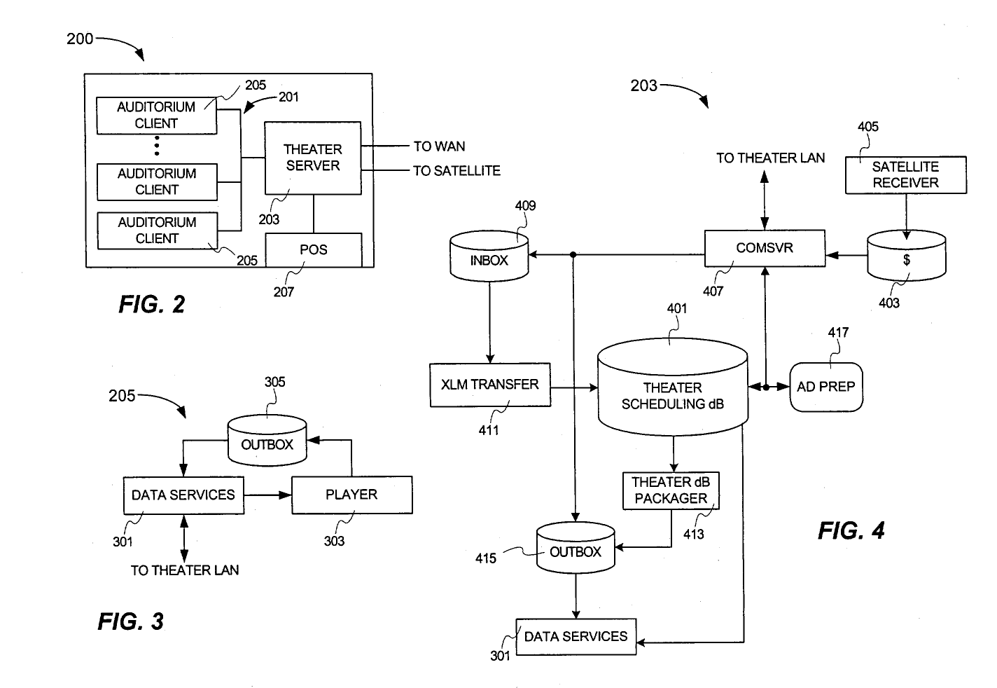

FIG. 1 shows an exemplary theatre environment 100 in which the present invention may be implemented. Environment 100 includes a plurality of theatre facilities 200, described in reference to FIG. 2, that are coupled to a data communication network such as wide area network (WAN) 101. Theatre facilities 200 may be distributed over any geographic area including regionally, nationally, or world-wide. A significant advantage of the present invention is that it enables coordinated advertising to be delivered to geographically and demographically diverse audiences. Because features of the present invention enable targeting to be improved over this diverse group of theatres 200, the market for advertisers is larger than with conventional regional-based in-theatre advertising systems. Moreover, because advertisements will reach a larger audience, advertisers can justify greater expense to produce advertising content, making the entire movie-going experience more enjoyable.

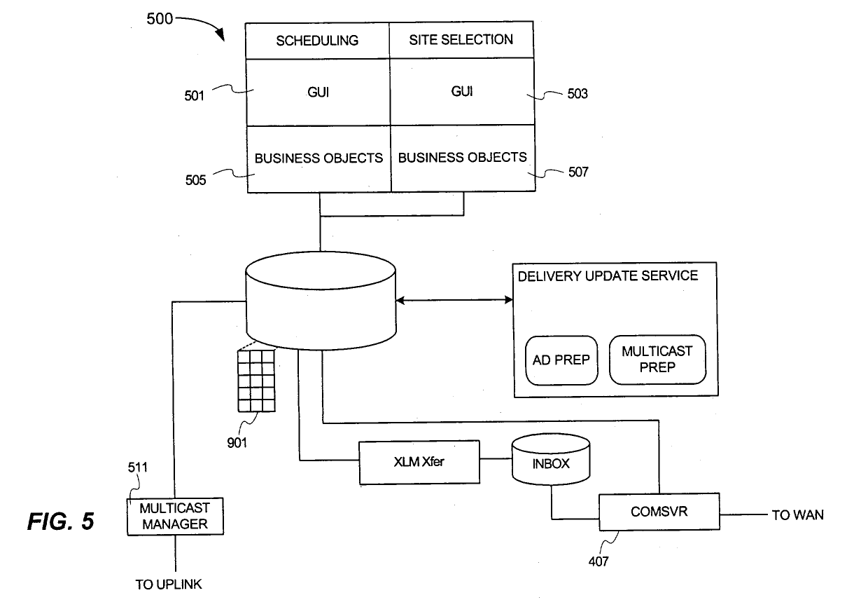

Environment 100 also includes one or more shared resources such as data server 500, described in greater detail in reference to FIG. 5. Data server 500 implements services to distribute content items 107 such as advertisements to appropriate theatres 200. Data server 500 also implements services to distribute scheduling information 109 that can be used by theatres 200 to create and present appropriate presentations such as pre-show features. In a particular example, data server 500 maintains a “schedule grid” 900 that contains inventory information on a per-auditorium basis where the inventory information is the collection of advertising slots of various characteristics that can be or have been sold.

WAN 101 may be implemented by any available networking technology and protocols including private networks and public networks such as the Internet, although in either case appropriate security and authentication protocols may be desirable to prevent unauthorized system access. WAN 101 is primarily configured to support full duplex communication between theatres 200 and data server 500 to exchange scheduling information 109 used to schedule presentation of content items, and to report back on the status of scheduled content items to verify their presentation. However, WAN 101 may also be used to distribute the content items 107 themselves in some circumstances.

Because the content files tend to be larger multimedia files, in the particular implementation of FIG. 1 environment 100 includes a high bandwidth broadcast/multicast communication link implemented, for example, by a digital broadcast satellite (DBS) 103 through satellite uplink 105. Satellite 103 may be a private system, or may be provided by a contact satellite operator such as Hughes Network Systems of Germantown Md. In the particular example, content items 107 comprise media files that, when played, range in length from a few seconds up to about 5 minutes. In other implementations such as digital cinema or event presentations, the content items 107 may comprise many minutes or even hours of material. The present invention is adaptable to any available encoding format and compression technique including proprietary mechanisms and industry standard formats such as MPEG-1, MPEG-2 and other MPEG standards that are available, “avi” files (audio video interleaved), “wav” (windows audio video), Windows Media audio and video files (identified by various file extensions such as asf, .asx, wax, .wm, .wma, .wmd, .wmp, .wmv, .wmx, .wpl, and .wvx), Macromedia flash (identified by “.swf” extensions), for example. Various file types, including raw data file types, may be used so long as appropriate encoding and decoding mechanisms are available to the system.

Hence, content files 107 may vary in size from a few thousand bytes to a many gigabytes or more when encoded using industry standard formats. Content files 107 may also comprise still images and/or audio files that are considerably smaller. Accordingly, the high bandwidth broadcast/multicast solution shown in FIG. 1 may be modified as needed, or eliminated in some cases, to meet the needs of distribution content items 107 used in a particular application. Suitable alternatives include terrestrial cable and microwave transmission and other data communication technologies.

In operation, content scheduling information 109 is distributed to specific theatres 200 that will use that scheduling information. For example, if a content item 107 is to be used only in theatres in New York City, scheduling information 109 associated with that content item 107 will be communicated only to theatres 200 that are in New York city. Scheduling information may be selectively communicated based on a variety of factors including geography, theatre size, number of auditoriums in the theatre 200, audience demographics, attendance rates, theatre sales volume, and the like as determined by the advertiser desires.

In a particular implementation, content items 107 are distributed using a full multicast to all theatres 200 irrespective of whether each theatre 200 will have use for the particular content item 107. Full multicast is efficient in implementations in which digital broadcast satellite is used because a single transmission reaches all theatres 200 at the same time. By transferring all content items 107 to all theatres 200 the need for re-transmission of any content item 107 is reduced or eliminated. Full multicast is particularly convenient in that content items 107 can be transferred in advance of scheduling information, enabling the scheduling system to remain completely flexible up until nearly the instant that a particular content item 107 is presented. Theatres 200 can then implement processes to selectively remove content items 200 that are not needed. Alternatively, content items 107 may be distributed by targeted multicast only to theatres 200 that will have use for the particular item. This selective distribution may conserve storage and processing resources at each of theatres 200 and therefore have advantages in some applications.

An important feature of the preferred implementations involves the separation of activities involved in managing content items 107 and activities involved in managing and communicating scheduling information 109. Prior systems of scheduling content display often resemble television broadcast systems in that they organize and arrange content at a central system and stream that content out to distributed presentation systems. In such systems, digital content could be cached or stored at various locations to simplify distribution, but the order and arrangement of the content items within a stream were fixed before the presentation. In many cases, the content would not be downloaded until after the schedule for that content's presentation was fixed.

In contrast, the present invention contemplates a system that distributes content items 107 asynchronously to the presentation system (e.g., a theatre or auditorium within a theatre). In many cases, the schedule information 109 is supplied to the presentation system after the content items 107 referred to by the schedule information 109 have been delivered. This enables the present invention to determine order and arrangement of content items 107 entirely independently of content distribution. In this manner, the presentation order and arrangement can be defined dynamically in the minutes or moments preceding the presentation of the content items. Because schedule information 109 will typically be much smaller than content items 107, the schedule information 109 can be communicated to the distributed presentation systems just in time for a presentation thereby ensuring the most current content items 107 and schedule information 109 are used.

The present invention contemplates both a push system in which content items 107 are pushed to particular theatres 200 or groups of theatres 200 that will use the content items, or by a pull a system in which theatres 200 request content items 107 that they will need. With respect to content items 107, delivery is primarily a push system so that content items 107 are distributed in advance of schedule information 109. In an exemplary push system, data server 500 initiates transfers of content items 107 to all or targeted auditorium clients 205 (shown in FIG. 2) within theatres 200. In an exemplary pull system, data server 500 generates but sends content items 107 to the appropriate theatre 200 in response to a specific request from an auditorium client 205. It is further contemplated that hybrid push-pull systems will be useful in many instances. For example, in a push system, theatre servers 203 and/or auditorium clients 205 may initiate a content pull if they discover that scheduled content items 109 have not yet been delivered by the push mechanisms.

Similarly, the present invention contemplates that scheduling information 109 (and commands related to scheduling) can be distributed by push or pull methods to theatres 200. In an exemplary push system, data server 500 initiates transfers of scheduling information 109 to appropriate auditorium clients 205 (shown in FIG. 2) within theatres 200. In an exemplary pull system, data server 500 generates scheduling information 109, but sends it to the appropriate theatre 200 in response to a specific request from an auditorium client 205.

FIG. 2, FIG. 3 and FIG. 4 together illustrate various data processing and storage components implemented in theatre facilities 200 in a specific implementation. The push and pull systems introduced above are implemented in particular examples with substantially similar data structures, although the precise implementation of data structures may be varied significantly from the specific examples given herein. As shown in FIG. 2, most theatres 200 comprise a theatre server 203 and a plurality of auditorium clients 205 coupled together by a theatre network 201. Theatre network 201 may comprise, for example, an available local area network (LAN) such as Ethernet, fibre channel, IP networks and the like having data transfer rates suitable to meet the needs of a particular application. Theatre server 203 implements communication interfaces with satellite 103 and WAN 101 shown in FIG. 1.

Theatre server 203 implements processes and data structures that are used to schedule and coordinate presentation of sequences of content items 107 in the form of, for example, pre-show presentations. Theatre server 203 may be provided as a stand-alone service or may be integrated or interfaced to other systems in a theatre 200. For example, in many theatres a central point of sale (POS) mechanism 207 is provided that maintains auditorium scheduling information that indicates which feature presentation will appear in a particular auditorium. This information is used, for example, to print tickets with specific auditorium information and to indicate when an auditorium is sold out, among other things. It is contemplated that the present invention may integrate with or interface to such a point of sale system such that theatre server 203 becomes aware of auditorium assignments, attendance, and/or other information automatically or semi-automatically. Alternatively, a management tool separate from or instead of the point of sale mechanisms may be provided where integration with a point of sale system is not available or practical. Theatre server 203 receives scheduling information 109, requests and receives content items 107 and implements caches for temporary local storage of content items 107 and scheduling information 109.

A theatre 200 comprises a one or more auditoriums. An auditorium is the room in which a film or feature is presented, and many theatres have one to perhaps twenty or thirty auditoriums. Each auditorium client 205 corresponds to a set of software processes that coordinate the presentation of content items 107 in a particular auditorium. Each auditorium will include projection equipment and audio equipment suitable for presenting a feature presentation (e.g., a film) and for presenting the content items 107 (e.g., in the form of a pre-show presentation). The projection and audio equipment may be the same for both types of presentations, although in current implementations the feature presentation equipment comprises conventional 35 mm projection equipment while the pre-show presentation equipment comprises digital projectors and digital audio equipment. Auditorium clients 205 may include interfaces for automating the projection/audio equipment, or the projection/audio equipment may rely on human operators.

FIG. 3 shows an embodiment of an auditorium client 105 in greater detail. Auditorium client 205 implements a connection to theatre LAN 201 and implements a data services instance 301 and one or more media player components 303. Data services component 301, an instance of which also appears in theatre server 203, comprises processes that handle communication with theatre server 203 through theatre LAN 201 and implement the communication protocols and resource allocation needed to support this communication. In a particular example, these communications use a proprietary protocol, although industry standard protocols and hybrid protocols may be appropriate in particular implementations. On the auditorium client 205, data services component 301 operates to access theatre scheduling database 401, shown in FIG. 4 and look up feature presentation times from a movie schedule record. Using this information, data services component 301 knows when to initiate a pre-show. For example, by determining that a movie is scheduled to start at 7:00PM, data service component will initiate a playback of a sequence of content items 107 at a specified time such as 6:40PM so that the sequence of content items 107 is presented as desired.

Optionally, processes are included, for example in data service component 301, to generate one or more notifications to a projectionist or to an automated projection system regarding the start time of a feature presentation. Currently, a feature presentation is provided on film and the film projector needs to be started in synchronization with the end of a pre-show. A human projectionist may be alerted by particular tones, blinking lights, a countdown timer, email notification and/or pager notifications. In a particular example a first notification is provided at 3 minutes before the feature presentation and a second notification is generated when the feature presentation is scheduled to start. This ensures the projectionist will be prepared after the break between shows. When automated projection equipment is involved, the notification can be made to the automated system to warm up the projector, start the projector or perform other theatre operations such as adjusting lighting, sound, curtains, screen level, and the like.

Player component 303 operates on the data items to drive the projection and audio equipment in a substantially conventional manner. Optionally, data services component 301 may be outfitted with processes to automatically control the projection and audio equipment. To implement a schedule-pull system, data services component 301 will include processes for polling theatre server 203 and/or data server 500 as needed to determine if there is any new scheduling information 109 that should replace the currently active scheduling information 109. Upon determination that new scheduling information 109 exists, a transfer of that new scheduling information is initiated. A particular client 205 may hold multiple play lists 600, but only one play list 600 is active at any given time. In a schedule push implementation, scheduling information is pushed to client 205 such that polling processes are not required.

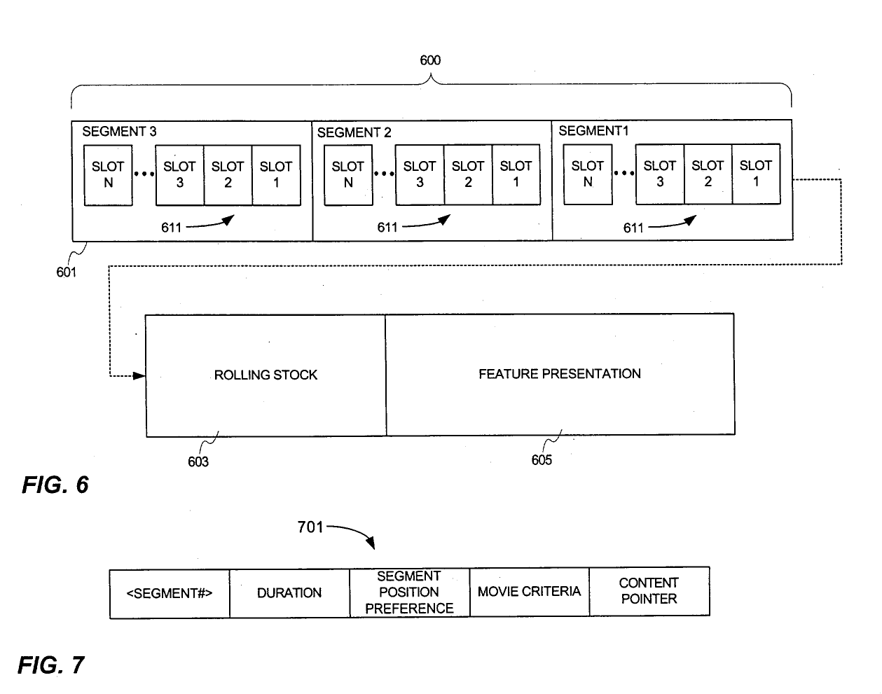

The sequence of content items 107 that is to be played by any particular auditorium client 205 is defined by a “play list” represented by a play list data structure 600 described in reference to FIG. 6. A play list 600 is generated by theatre server 203 and/or data server 500 from the inventory information contained in schedule grid 900 (shown in FIG. 1 and FIG. 9). A play list 600 is specific to a particular auditorium client 205, although it is contemplated that two or more auditorium clients 205 may have similar play list 600. Play list 600 is communicated to data services component 301 in addition to the information about movie start time. In a particular example, data services component 301 implements a cache structure (not shown) for holding a copy of the content items 107 that will be included in a particular sequence being presented. Alternatively, data services component 301 may be used to pull cached content items 107 from storage within theatre server 203.

In a particular example, outbox 305 is used to store messages indicating summary information about the status of the presentation of data items 107. As a data item is played, a message (e.g., an XML document) is created to indicate information such as the time at which the data item 107 played, the auditorium in which it played, and the like. It is contemplated that any level of detail about the playback may be maintained in this manner. The playback message may contain information about the audience size, audience demographic information, or information indicating the feature presentation that is scheduled to be presented in conjunction with the data item 107. This record is transmitted through data services 301 to theatre server 203 and can be used to provide an auditable record of advertisement presentations. Some prior audit systems create a record each time a content item is decrypted for licensing purposes, but such records do not actually confirm that a particular content item has been presented. In contrast, the present invention allows a positive confirmation that a content item was actually presented.

FIG. 4 illustrates functional components of an exemplary theatre server 203 in greater detail. Theatre server 203 services all auditorium clients 205 in a given theatre facility 200. Content items 107 are received through satellite receiver interface 405 and stored locally in cache data store 403. A comsvr component 407 implements processes to support both push and pull functionality for accessing content items and populating cache 403 with content items 107. In the case of a content push system it is possible that many content items 107 will be delivered that have little or no use in a particular theatre server 203. Theatre server 203 implements processes, for example within comsvr component 407, that manage cache data store 403 using an appropriate algorithm such as least recently used (LRU), time in cache, first in first out, or the like.

In a particular implementation, comsvr component 407 checks for updated schedule information 109 that is ready to be sent to theatre server 203. This update service is used in two primary logical locations; at the data center 500, to push out updated schedule information 109 and in theatre server 301 to push updated content items 107 and play-lists 600 to the auditorium clients 205.

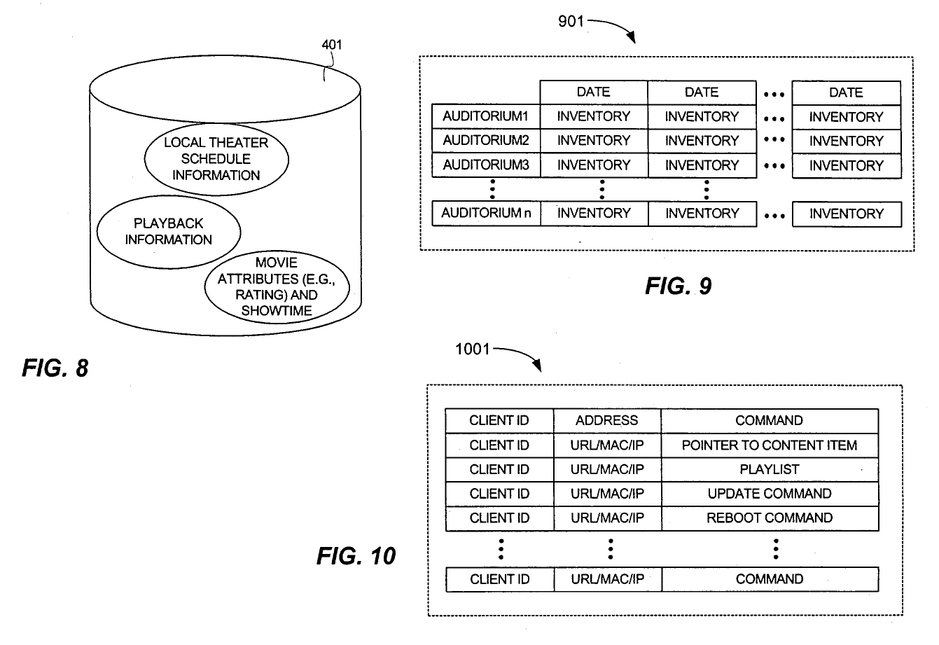

Theatre schedule database 401 is implemented, for example, by an MSDE (Microsoft data engine) database available from Microsoft Corporation. However, any available database engine may be used such as mySQL database server from mySQL AB, Oracle database produces from Oracle Corporation and the like. As shown in detail in FIG. 8, theatre schedule database 401 stores the local theatre 200 schedule information 109 as well as information regarding movie attributes and show times. Theatre schedule database 401 serves as a collection point for advertisement playback transaction data received through inbox 409 and XML transfer component 411. That is, theatre schedule database 401 stores the XML records that hold information about which ads played in which auditoriums and when. The playback information is communicated through theatre database packager 413 and outbox 415 to data center 500 on a regular basis. Theatre database packager 413 operates to reformat and/or aggregate playback records to simplify communication and handling, if desired.

Data services component 301, which is substantially similar to that described in reference to FIG. 3, is used on theatre server 203 to handle the delivery of updated schedule data. Data services component 301 is adapted to connect to local theatre schedule database 401 and update it accordingly. Alternatively, this function may be handled by the Play List Prep service 417. Play list Prep service 417 comprises a set of processes that manage the play-list generation within the theatre facility 200 it is serving. Play List Prep service 417 reads a schedule grid 900 (shown in FIG. 1 and FIG. 9) to obtain inventory information for each auditorium client 205 in that theatre 200 and uses this information to determine what the play list 600 for each auditorium client 205 should look like and when it should be delivered.

Prep service 417 then creates a “queue table” 1001 (shown in FIG. 10) which is essentially a command queue representing various scheduling information and other commands to be implemented in a particular client 205. Queue table 1001 includes a plurality of entries where each entry corresponds to a particular command to be implemented. Each entry identifies the auditorium client 205 and a network address of that auditorium client 205 (e.g., an IP address, MAC address, uniform resource locator or the like). Each entry includes some command/scheduling information such as a pointer to a content item 107, a play list 600 or pointer to a play list 600, or an op-code for a particular operation such as to activate a particular play list 600 or reboot the client 205.

In operation, entries in Q-table 1001 are distributed to the specified client 205 and executed by that client 205. Play List Prep service 417 creates the play list and queues up necessary content items 107 just before the play list 600 is supposed to start. This just-in-time system ensures that the latest scheduling information 109 is being used. For example, if an advertiser has modified the content item(s) 107 that are intended to be presented, Play List Prep service 417 will note the change and ensure that the auditorium client 105 uses the updated content item 107 rather than stale content that might have been previously transferred. Further, the last minute generation of a play list 600 will contain a correct play list 600 even when last minute auditorium changes occur.

FIG. 5 illustrates functional components and processes implemented by data center 500 in a particular embodiment. A scheduling user interface 501 is configured to accommodate data display and entry for creating scheduling information 109. The scheduling information 109, includes an “advertising contract record” 701 that is shown in greater detail in FIG. 7. A site selection interface 503 is configured to accommodate data display and entry for allowing the specification of presentation requirements, presentation preferences, geographic preferences, or any other criteria recognized by the particular. implementation. Advertising contract records 701 are scheduled by placing them into inventory represented in scheduling grid 901. It is also contemplated that data center 500 may maintain a table that specifies contracts are considered ‘default’ contracts”. Default contracts may identify entertainment items, general interest announcements, non-revenue advertisements that present information on how to purchase advertising space, and the like. Default contracts may be added to a play list 600 when there is unused inventory for a particular day at a particular client 205.

FIG. 6 illustrates an exemplary data structure for a play list 600. A play list 600 can be broken down into a number of different segments 601. Each segment 601 can be specified to be a different length and/or contain a different number of slots 611. In a particular implementation, each slot 611 represents 15 second time window and may point to at most a single advertisement (i.e., content item 107). Within each segment 601 content items 107 can be weighted by specifications from the advertising contract record such that the content items 107 will tend to be placed in slots towards the beginning or end of a segment 601 depending on the desired result. For example an advertiser may decide they want content items 107 to be in the third segment 601 of the play list 600, but they want to be the last ad played within that segment 601. The play list 600 is followed by, for example a rolling stock presentation 603 and a feature presentation 605. Optionally, where theatre automation components are used, the play list 600 may specify the state of other controllable features of the theatre environment such as lighting levels, volume levels and the like.

FIG. 7 illustrates an exemplary advertising contract record that contains scheduling information 109 related to a particular content item 107. This information includes, for example, presentation requirements designated by the advertiser such as a requirement that the associated data item be presented with a particular movie rating. This information also includes presentation preference information such in which segment of play list 600 the data item should appear and whether there is a preferred slot within the segment. Information about the duration of the data item which may be measured in terms of a number of slots consumed, is also included.

The processes involved in the present invention include sales and marketing processes enabled by the present invention. For example, when sales personnel meet with an advertiser to determine requirements and preferences with respect to particular advertisement the advertiser may specify geographic requirements, presentation requirements, or the like as described above. The sales personnel create a “customer proposal” using the processes referred to herein as a “Proposal Machine”. The proposal indicates, for example, the number of theatres 200 selected, pricing information, the length of the proposed engagement and the segment of the play list 600 they would like the advertisement to appear in.

Once the client agrees to the proposal, the proposal is converted into an advertisement contract 701. A scheduler then schedules the contract into a schedule grid 901, following the proposal details of length of contract, sites selected, rate(s), position(s) in play list, as well as movie rating. Once scheduled, a play list 600 is generated and entries in Q-table 1001 are generated. Clients 205 then follow the directions from the Q-table 1001 to cause presentation of advertisements according to the scheduled contracts.

The present invention allow proposals to be written without “total” knowledge of the future. For example, it is possible to estimating the number of screens available for a particular advertisement requirement using average percentages of movies that are classified with each movie rating. From this estimate “virtual auditoriums” can be as being “place holders” for movies of a particular rating. The system can then schedule media buys to the place holder auditoriums, thereby selling this “virtual inventory” before it actually comes into existence, and tracking that inventory through the term of the contract. As specific films are scheduled in specific auditoriums, real inventory becomes available and the contracts can be reassigned to an appropriate auditorium. The system of the present invention is desirably able to reconcile this virtual inventory against the actual inventory that is created at show time.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A method of scheduling pre-show feature presentations in a theatre comprising:
providing content items in a theatre server;
storing a plurality of advertising contract records at the theatre server, each advertising contract record identifying a particular content item and including scheduling data associated with that particular content item, wherein the scheduling data includes at least one item of information that correlates to a particular presentation criteria that must be satisfied when the content is presented;
storing theatre schedule information indicating particular feature presentations will be presented in particular auditoriums, the scheduling information including at least one attribute of the feature presentation;
building a pre-show play list for a particular auditorium by:
selecting contract records that will have their presentation criteria satisfied by the at least one attribute specified in the theatre schedule information; and
arranging content items associated with each of the selected contract records to form the pre-show play list.

2. The method of claim 1 wherein the advertising contract records further comprise information indicating preferred time criteria and the act of arranging content items uses the preferred time criteria to determine an order of content items in the play list.

3. The method of claim 1 wherein the presentation criteria comprises a movie rating.

4. The method of claim 1 wherein the presentation criteria comprises a movie title.

5. The method of claim 1 wherein the act of providing content items comprises:
requesting at least one of the content items in digital form from a first digital communication network after selecting a contract record that identifies the at least one content item; and
storing the requested content items locally in the theatre server.

6. The method of claim 1 wherein the act of providing content items comprises:
receiving the content items in digital form from a first digital communication network before selecting a contract record that identifies the at least one content item; and
storing the requested content items locally in the theatre server.

7. The method of claim 1 wherein the pre-show play list is organized as a plurality of segments where each segment contains one or more slots and the act of arranging content items to form the play list comprises placing the content items into particular slots.

8. The method of claim 7 wherein the segments have a variable length determined by the number of slots contained therein.

9. The method of claim 7 wherein the contract record specifies a weight value and the act of arranging content items to form the play list further comprises using the weight value to locate a particular content item in a particular slot within a segment.

10. The method of claim 7 wherein the act of building a play list further comprises selecting filler content for time slots within a play list that do not satisfy a contract record.

11. An advertising contract record for use in presenting in-theatre advertising, the contract record comprising:
identification of particular advertisement content;
specification of at least one presentation criteria that must be satisfied when the content item is presented; and
specification of at least one presentation preference that is desirably satisfied when the content item is presented.

12. The advertising contract record of claim 11 wherein the presentation criteria comprises a movie rating.

13. The advertising contract record of claim 11 wherein the presentation criteria comprises a geographic criteria.

14. The advertising contract record of claim 11 wherein the presentation criteria comprises audience demographic criteria.

15. The advertising contract record of claim 11 wherein the particular advertisement content comprises an industry standard format media file.

16. The advertising contract record of claim 11 wherein the particular advertisement content comprises an MPEG-2 format media file.

17. A pre-show play list data structure comprising:
a plurality of segments;
one or more slots within each segment, each slot configured to identify at least a portion of a content item such that the pre-show play list defines a sequence of content items that will be presented in a particular order.

18. The pre-show play list of claim 17 wherein the segments have a variable length.

19. The pre-show play list of claim 17 wherein the segments contain a variable number of slots.

20. A method of building a pre-show play list in a manner that satisfies presentation criteria specified by advertisers, the method comprising the acts of:
obtaining advertising contract records indicating the presentation criteria from a remote source;
obtaining auditorium scheduling information, the auditorium scheduling information including attributes of a feature being presented within a particular auditorium;
building the pre-show play list in a just-in-time manner prior to the beginning of the feature being presented within the particular auditorium by matching the presentation criteria with the attributes of the feature being presented to select a set of advertisements for the pre-show play list.

21. The method of claim 20 further comprising the act of:
arranging the selected set of advertisements in an order within the play list that satisfies presentation preferences specified by the advertisers.

22. The method of claim 20 further comprising:
verifying that a media file associated with each advertising contract is available.

23. The method of claim 20 wherein the act of obtaining the auditorium scheduling information comprises accessing the auditorium scheduling information from an in-theatre point of sale (POS) system.

24. A movie theatre comprising:
a plurality of auditoriums;
presentation mechanisms within each auditorium operable to present visual and/or audio features to an audience;
a mechanism for scheduling a particular feature presentation that will appear in a particular auditorium;
a system for presenting a plurality of pre-shows before feature presentations, where each pre-show is specified for a particular auditorium and each pre-show comprises a sequence of media files, wherein the system for presenting comprises:
a pre-show play list data structure for each pre-show, the play list data structure defining the sequence of media files that make up the pre-show;
media player components coupled to the presentation mechanisms and operable to play the sequence of media files defined by the pre-show play list;
update services executing in the system for presenting and operable to detect changes that impact any one of the pre-show play lists; and
a play list generator operable to create a replacement pre-show data structure in response to identifying a pre-show play list that is impacted by a change.

25. The theatre of claim 24 wherein the changes detected by the update service comprise changes in advertising contract information.

26. The theatre of claim 25 wherein the changes detected by the update service comprise changes in a feature presentation scheduled for a particular auditorium.

27. The theatre of claim 25 wherein the system for presenting further comprises an interface to an external data center having current advertising contract information.

28. The theatre of claim 27 wherein the data center services a plurality of theatres.

29. A system for presenting digital media content in conjunction with a feature presentations in a multi-auditorium movie theatre, the digital media content comprising a sequence of media files and the system for presenting comprising:
a play list data structure maintained for each auditorium, the play list data structure defining the sequence of media files that make up a show, where each show is associated with a particular auditorium;
update services operable to detect changes that impact any one of the play lists; and
a play list generator operable to update the play list data structures in response to identifying a play list that is impacted by a change.

30. The system of claim 29 wherein the changes detected by the update service comprise changes in advertising contract information.

31. The system of claim 30 wherein the changes detected by the update service comprise changes in a feature presentation scheduled for a particular auditorium.

32. The system of claim 30 wherein the update services further comprise an interface to an external data center having current advertising contract information.

33. An auditable system for presenting in-theatre advertising comprising:
a play list generator having access to advertiser-specified presentation criteria and having access to real time theatre scheduling information;
a plurality of advertisement media files, wherein each advertisement media file is associated with at least some advertiser-specified presentation criteria;
logic implemented within the play list generator to select advertisement media files based on both the advertiser-specified presentation criteria and having access to real time theatre scheduling information; and
a presentation record holding confirmation information describing presentation of a particular advertisement media file.

34. The system of claim 33 wherein the presentation record includes information about a feature film was that was presented in conjunction with the presentation of the particular advertisement media file.

35. The system of claim 33 wherein the presentation record includes information about a particular auditorium in which the particular advertisement media file was presented.

36. The system of claim 33 wherein the presentation record includes information about an audience to which the particular advertisement media file was presented.

37. The system of claim 33 wherein the presentation record includes information about when the particular advertisement media file was presented in relation to start of a feature film was that was presented in conjunction with the presentation of the particular advertisement media file.

38. The system of claim 33 wherein the presentation record includes information about when the particular advertisement media file was presented in relation to others of the selected advertisement media files.

39. The system of claim 33 wherein the theatre scheduling information includes movie attributes.

40. The system of claim 33 wherein the theatre scheduling information includes audience attributes.

41. A method for auditing presentation of advertising comprising the acts of:
providing a plurality of advertisement media files, wherein each advertisement media file is associated with at least one advertiser-specified presentation criteria;
generating a play list based on advertiser-specified presentation criteria;
generating a presentation record holding confirmation information describing presentation of a particular advertisement media file; and
communicating the presentation record to a data processing machine.

42. The method of claim 41 further comprising a communicating the presentation record to a central database.

43. The method of claim 41 further comprising processing a plurality of presentation records to generate summary reports.

44. The method of claim 41 further comprising:
analyzing one or more presentation records to determine whether the advertiser-specified presentation criteria have been satisfied.

45. The method of claim 44 further comprising:
adjusting a future play list to satisfy advertiser-specified presentation criteria in response to determining that an advertiser-specified presentation criteria has not been satisfied.

46. A movie theatre network comprising:
a data communication mechanism;
a data center coupled to the data communication mechanism;
a data center data store associated with the data center;
a plurality of media content files stored in the data center data store;
a set of presentation criteria associated with each of the media content files;
a plurality of theatre servers coupled to the data communication mechanism, wherein each theatre server is associated with a particular theatre location;
a scheduling information protocol for distributing scheduling information including the presentation criteria from the data center to selected ones of the theatre servers;
a media file protocol for distributing selected media files from the data center to particular theatre servers; and
presentation mechanisms within each theatre servers for presenting received media files in a manner that satisfies requirements of the scheduling information.

47. The movie theatre network of claim 46 wherein at least some of the theatre locations comprise multiple auditoriums, and the system further comprises:
an auditorium client associated with each auditorium and in communication with the theatre server associated with the particular theatre location at which the auditorium exists.

48. The movie theatre network of claim 46 wherein the data communication mechanism comprises:
a first data path configured to communicate scheduling information between the data center and the theatre servers; and
a second data path configured to transfer the media content files from the data center to the theatre servers.

49. The movie theatre network of claim 46 wherein the data communication mechanism comprises a shared data path configured to communicate scheduling information between the data center and the theatre servers and configured to transfer the media content files from the data center to the theatre servers.

50. A system for distributing sequences of digital content comprising:
a plurality of content items;
communication mechanisms for transmitting the content items to a plurality of distributed presentation locations;
storage at each of the plurality of distributed presentation locations for storing the content items;
a central scheduling mechanism operable to distribute schedule information to the plurality of distributed presentation locations, wherein the schedule information is distributed independently from the content items; and
presentation mechanisms at the plurality of distributed presentation locations coupled to read the schedule information, select content items in response to the schedule information, and present the selected content items to form the sequence of digital content.

51. The system of claim 50 wherein the schedule information is distributed asynchronously from the content items.

52. The system of claim 50 wherein the presentation mechanisms are configured to present the content items in a sequence defined by the schedule information.

53. The system of claim 50 wherein the content items are communicated before the scheduling information.

54. A movie theatre comprising:
one or more display locations;
presentation mechanisms at each display location operable to present visual and/or audio features to an audience;
a mechanism for scheduling a particular feature presentation that will appear on each presentation mechanism at each of the one or more display locations;
a system for presenting a plurality of shows, where each show is presented on at least one presentation mechanism and each show comprises a sequence of media files, wherein the system for presenting comprises:
a play list data structure for each show, the play list data structure defining the sequence of media files that make up the show;
media player components coupled to the presentation mechanisms and operable to play the sequence of media files defined by the show play list;
update services executing in the system for presenting and operable to detect changes that impact any one of the play lists; and
a play list generator operable to create a replacement play list in response to identifying a play list that is impacted by a change.
